(19) United States
(12) Patent Application Publication
(10) Pub. No.: US 2006/0010321 A1
(43) Pub. Date: Jan. 12, 2006

(54) Network system, data transmission device, session monitor system and packet monitor transmission device

(76) Inventors: Hitomi Nakamura, Tokyo (JP); Kenichi Sakamoto, Kawasaki (JP); Hidenori Inouchi, Tokyo (JP); Yukiko Takeda, Tokorozawa (JP); Takashi Miyamoto, Yokohama (JP)

Correspondence Address: REED SMITH LLP, Suite 1400, 3110 Fairview Park Drive, Falls Church, VA, 22042, US

(21) Appl. No.: 10/927,586

(22) Filed: Aug. 27, 2004

(30) Foreign Application Priority Data
Jul. 12, 2004 (JP) 2004-204066

(51) Int. Cl. H04L 9/00

(52) U.S. Cl. 713/168

(57) ABSTRACT

In a network system for communication between a first terminal with an encrypting function and a second terminal without the encrypting function, a control data transmission device includes a receiving unit receiving control data sent from the first terminal to the second terminal, a data processing unit for extracting cipher information of the first terminal from the control data, a memory storing the cipher information of the first terminal, and a sending unit for sending the control data without the cipher information toward the second terminal, or sending to the first terminal the control data with the cipher information, and further sending the cipher information to the user data transmission device; a user data transmission device includes an encryption processing unit for decrypting the data that was sent from the first terminal to the second terminal while encrypting the data as sent from the second terminal to the first terminal.

### CLAIM OF PRIORITY

The present application claims priority from Japanese application JP2004-204066 filed on Jul. 12, 2004, the content of which is hereby incorporated by reference into this application.

### BACKGROUND OF THE INVENTION

The present invention relates to session transmission systems for allowing a signaling (control data) transmission device and a data (user data) transmission device to perform encryption processing in cooperation with each other.

In recent years, IP telephones are becoming more widely used in various locations such as business entities and homes. It becomes an important technical issue to encrypt or cipher the communication contents in order to provide protection of subscriber's privacy and also preclude information leakage to an unauthorized person.

Typically, a procedure for performing encrypted communications includes the steps of:
(1) performing exchange of parameters necessary for encryption processing (referred to as encrypto or cipher information hereinafter) and authentication of a party or person at the other end of a line; and
(2) encrypting a packet(s) in accordance with the contents thus exchanged. In the case of IP phones, it has been contrived to employ a scheme for performing the above-noted step (1) in the signalling process. For example, in cases where the session initiation protocol (SIP) defined by RFC3261 is used for such signaling, exchange is done while letting the signaling contain cipher information that is described by use of the session description protocol (SDP) defined by RFC2327. This scheme is standardized in a way as taught by documents 1) IETF RFC2327 “SDP: Session Description Protocol,” April 1998, pp. 17-18, 2) IETF Draft “Session Description Protocol Security Descriptions or Media Streams,” October 2003, http://www.ietf.org/internet-drafts/draft-ietf-mmusic-sdescriptions-02.txt, and 3) IETF Draft “Key Management Extensions for Session Description Protocol (SDP) and Real Time Streaming Protocol (RTSP),” October 2003, http://www.ietf.org/internet-drafts/draft-ietf-mmusic-kmgmt-ext-09.txt.

In the case of using RTP defined by RFC3550 for data transfer, the processing step (2) stated above is defined as specific protocols including, but not limited to, Secure RTP (SRTP) and IPsec. An example of the SRTP is disclosed in the document IETF RFC3711 “The Secure Real-time Transport Protocol,” March 2004. The basic definition of the IPsec is found in IETF RFC2401 “Security Architecture for the Internet Protocol,” April, 1998. SRTP is a scheme for performing encryption at an application layer as one function of RTP. IPsec is a scheme for performing encryption at a network layer, which is the same as IP.

In prior known communications systems, it is a terminal that sets up the cipher information to be contained in the signaling. Examples of this approach are disclosed in U.S. Patent Application Publication 2003/0110292 and JP-A-2003-46646. As suggested by these Japanese patent documents, in the event that a signaling transmission device and a data transmission device are cooperated together to perform communication protocol conversion and monitoring of communication contents, the remaining session information items (such as data communication-use IP address, port number and others) are rewritten by an transmission device in a half way. However, even in such system, the cipher information is set up by a terminal per se and is then subjected to terminal-to-terminal exchange.

### SUMMARY OF THE INVENTION

In the prior art systems, it is not possible to perform encrypted communications in cases where terminals are not identical in encrypting ability to each other.

Additionally in the prior art systems, it is impossible to perform, on the network side, monitoring and recording of terminal-to-terminal communication contents.

To solve the first problem stated above, a signaling transmission device is arranged to comprise means for adding or deleting cipher information to or from a signaling message, and means for notifying the cipher information to a data transmission device. The data transmission device has means for performing data encryption and decryption based on the cipher information that was notified from the signaling transmission device.

To solve the second problem, a signaling transmission device is provided which has the function of notifying a monitor device or alternatively a recording device of the cipher information that is involved in the signaling. Either the monitor device or the recording device comprises means for performing data decryption based on the cipher information as has been notified from the signaling transmission device.

It is possible to provide a system capable of performing encrypted communications with flexibility, which has been unattainable in the prior art.

Other objects, features and advantages of the invention will become apparent from the following description of the embodiments of the invention taken in conjunction with the accompanying drawings.

### BRIEF DESCRIPTION OF THE DRAWINGS

FIGS. 1A and 1B are diagrams each showing a configuration of a first communications network in accordance with a first embodiment of the invention.

FIG. 2 depicts a sequence example 1 in the first embodiment.

FIG. 3 shows an example of “SIP INVITE” message which contains cipher information.

FIG. 4 is a functional block diagram of a session transmission device 3.

FIGS. 5A to 5C show exemplary structures of tables provided in a session transmission device 13.

FIG. 6 shows a sequence example 2 in the first embodiment.

FIG. 7 is a function block diagram of an SIP transmission device 13.

FIG. 8 is a function block diagram of a data transmission device 16.

FIGS. 9A and 9B are diagrams each showing a configuration of a second network in the first embodiment.

FIGS. 10A-10B are diagrams each showing a configuration of a third network in the first embodiment.

FIG. 11 shows a sequence example 3 in the first embodiment.

FIG. 12 shows an exemplary configuration of a network in a second embodiment.

FIG. 13 is a diagram showing a communication sequence 1 in the second embodiment.

FIG. 14 is a function block diagram of an SIP transmission device in the second embodiment.

FIG. 15 is a function block diagram of a monitor device in the second embodiment.

FIG. 16 is a diagram showing a communication sequence 2 in the second embodiment.

FIGS. 17A-17B show processing routines of a session transmission device 3.

FIGS. 18A-18B show processing routines of an SIP transmission device and a monitor device in the second embodiment.

### DESCRIPTION OF THE INVENTION

Embodiments of the present invention will be explained with reference to the accompanying drawings below.

In the embodiments, examples are described which employ SIP for the signaling protocol while using RTP for data transmission and using SRTP for data encryption.

### Embodiment 1

In prior art systems, cipher information is exchanged between terminals so that encrypted communications are hardly achievable in cases where these terminals are not identical to each other in encrypting ability. An alternative approach is to perform communication in the form of plaintexts or to inhibit communication. In cases where communication is done using plaintexts, there is a risk that the confidential information of business entities or companies can be leaked to the third party over networks in the circumstance that one terminal is connected to a corporate network and another terminal is connected to the Internet, by way of example.

Consequently, in a first embodiment, there is shown an example of the invention which solves the above-noted problem.

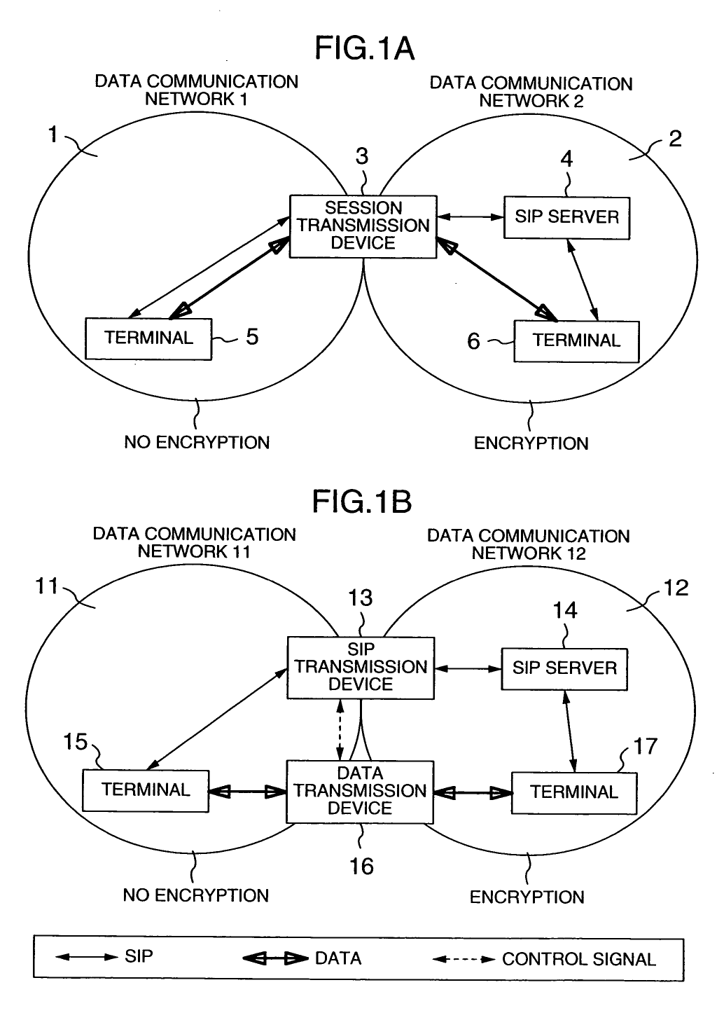

FIGS. 1A and 1B are diagrams each showing a first network configuration example of a communications system that avoids the first problem. This configuration is applicable, for example, to IP centrex services that an IP telephone service company provides PBX functions to subscriber companies via IP networks.

FIG. 1A depicts an example which assembles together a signaling transmission device and a data transmission device in the same housing. FIG. 1B shows an example with these devices assembled in separate housings respectively. In the description below, a sequence example and device arrangement will first be indicated in regard to FIG. 1A, followed by an explanation of FIG. 1B.

The communications system shown in FIG. 1A is constructed on a data communication network 1 and another data communication network 2. At the boundary between these data communication networks 1 and 2, a session transmission device 3 is installed. This session transmission device 3 has both a signaling transmission function and a data transmission function. Additionally an SIP server 4 is provided in the data communication network 2, for accommodation of a terminal 5 of the data communication network 1 and a terminal 6 of data communication network 2. It should be noted that this embodiment assumes that the data communication network 1 is implemented as a corporate network whereas the data communication network 2 is an IP telephone network, such as ISP or the like. It is also assumed that the terminal 5 of data communication network 1 has no encrypting abilities, while the terminal 6 of data communication network 2 has encrypting abilities.

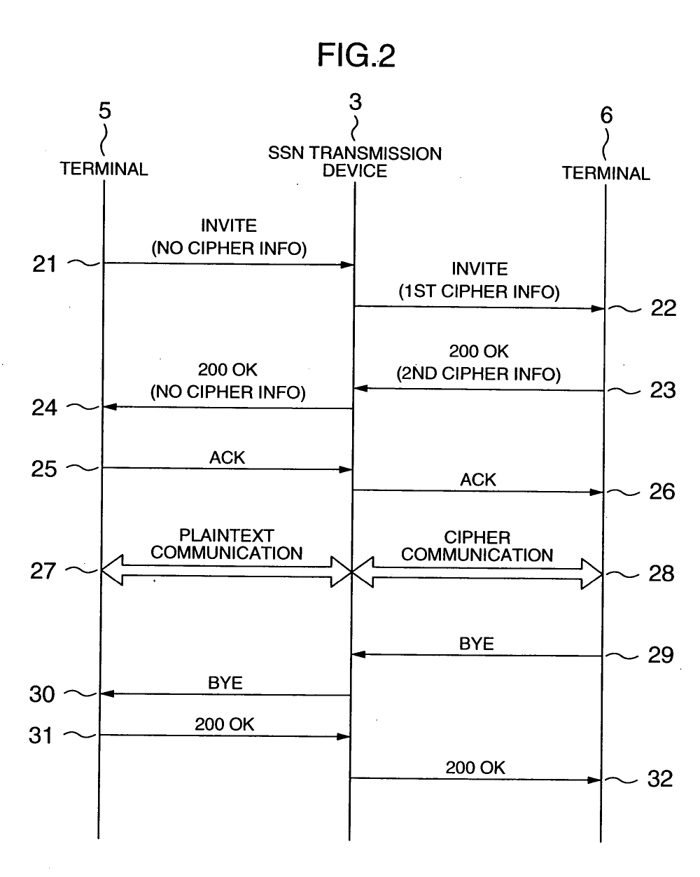

An operation of the session transmission device 3 will be explained by use of a sequence example of FIG. 2. Firstly, the terminal 5 transmits a phone-call start request (INVITE) (as indicated by reference numeral 21). This call start request does not contain any cipher information, because the terminal 5 does not have any encrypting function. Upon receipt of this call start request from the terminal 5, the session transmission device 3 adds thereto first cipher information and then transfers it toward the terminal 6 (as indicated by numeral 22 in FIG. 2). Upon completion of the preparation for a telephone call, the terminal 6 sends back a success response (200 OK) which contains second cipher information and then starts transmission and reception of data (indicated by 23). The session transmission device 3 receives the success response from the terminal 6 and then deletes the second cipher information from the success response, followed by transmission to the terminal 6 (24). When receiving the success response in reply to INVITE, the terminal 5 returns ACK (Acknowledge) and starts transmission/receipt of data (25). When ACK was transmitted to the terminal 6, the session transmission device 3 begins to execute data transmission processing (27, 28). In this event, data communication between the session transmission device 3 and the terminal 6 is subjected to encryption in accordance with a certain scheme that was determined based on the first and second cipher information. When the communication is set in disconnection, the terminal 6 sends forth a communication end request (BYE) by way of the session transmission device 3 so that data communication is terminated (29, 30). The terminal 5 sends back thereto a success response and thereafter terminates a presently established data communication (31, 32). The session transmission device 3 completes the data transmission processing after the disconnection processing at 29-32 of FIG. 2.

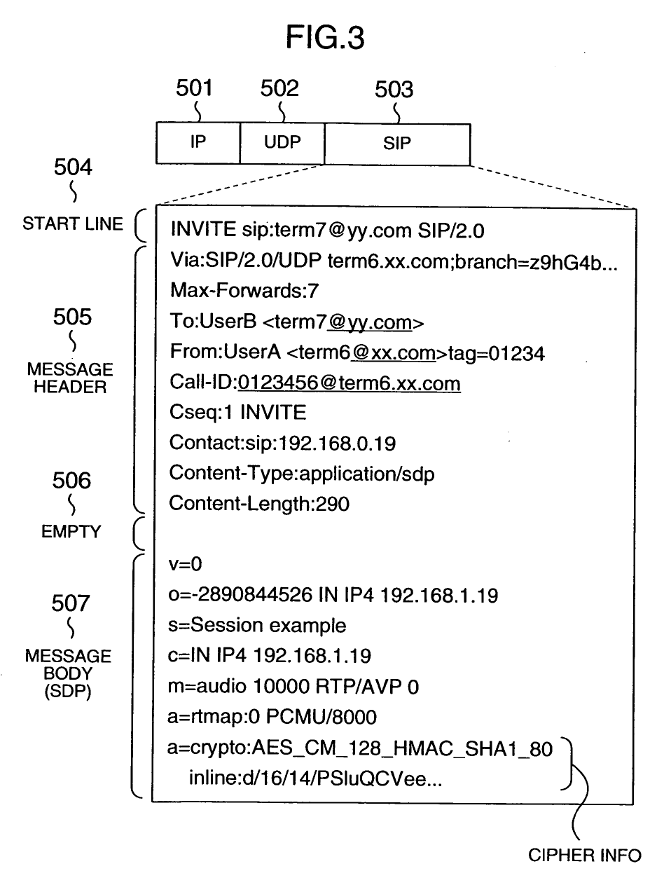

FIG. 3 shows an exemplary SIP packet format of the call start request that contains cipher information. The SIP packet is generally made up of an IP header part 501, a UDP header part 502, and an SIP message part 503. The SIP message 503 is divided into an SIP start line 504, SIP message header 505, empty line 506, and SIP message body 507. The empty line and SIP message body may be absent in some cases. A plurality of ones may be present in series in other cases.

The cipher information indicated in this example is the one that describes several parameters required for SRTP processing in accordance with a specific form as defined by IETF Draft “Session Description Protocol Security Descriptions or Media Streams,” October 2003. The form as used herein is presented below.

$$a = crypto \text{:} crypto \text{-} suites key \text{-} param \\ * ( session \text{-} param )$$

The “crypto-suites” indicates the type of an encryption algorithm and/or authentication algorithm. For example, AES_CM_{—}128_HMAC_SHA1_80 indicates that the encryption algorithm is an AES CTR mode with 128 bits of key length and that the message authentication algorithm is HMAC_SHA1 with 80 bits of tug length.

“key-param” is a field which designates information as to the key(s) and which describes parameter(s) just next to “inline:” in a form which follows:
“use/key_length/salt_length/BASE64(key| |salt)/lifetime/MKI: MKI_length,”
   where,
use: Key usage (d=decrypt, e=encrypt, b=decrypt/encrypt)
key_length: Byte length of SRTP master key
salt_length: Byte length of master salt
key| |salt: Combination of master key and master salt
lifetime: Lifetime of master key (processable packet number)
MKI: Identifier assigned to master key
MKI_length: Bit length of MKI

The term “session-param” is an option, for which five forms are defined, although not specifically shown in FIG. 3. These forms are given below.

(1) SRC=SSRC/ROC/SEQ

This gives initial information of SSRC, ROC and SEQ.

(2) KDR=n

This designates the update rate of a session key.

(3) UNENCRYPTED_SRTCP and UNENCRYPTED_SRTP

These indicate no execution of SRTCP encryption and SRTP encryption, respectively.

(4) FEC_ORDER=order

This shows the order of FEC and SRTP processing tasks on the sender side.

(5) UNAUTHENTICATED_SRTP

This shows that SRTP message authentication is not done.

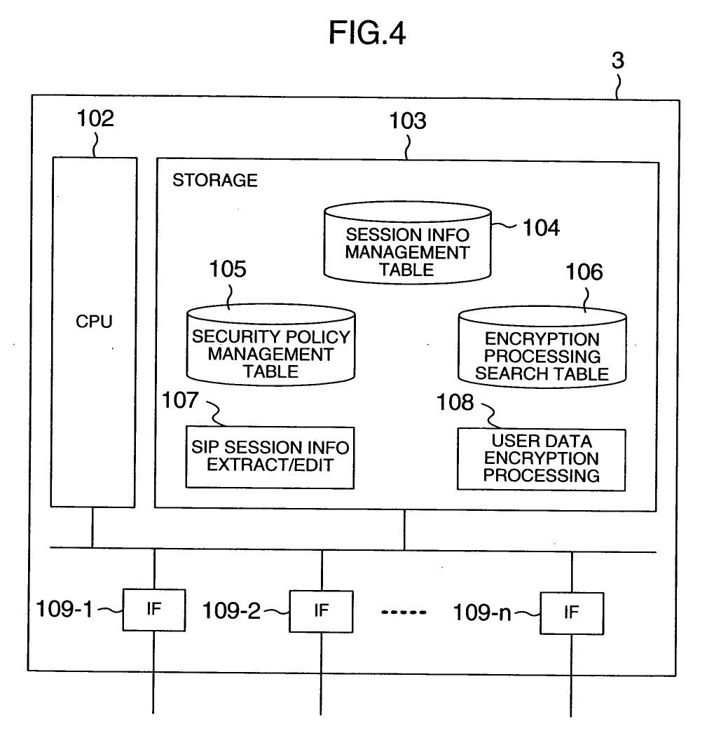

FIG. 4 depicts an exemplary configuration of the session transmission device 3. This device is arranged to include interface units 109-1, 109-2, . . . , 109-n for accommodation of network lines, a storage device 103, and a central processor unit (CPU) 102, which are linked together via data transfer buses. The storage device 103 stores therein an SIP session information extract/edit program 107, a user data encryption processing program 108, a security policy management table 105, an encryption processing search table 106, and a session information management table 104.

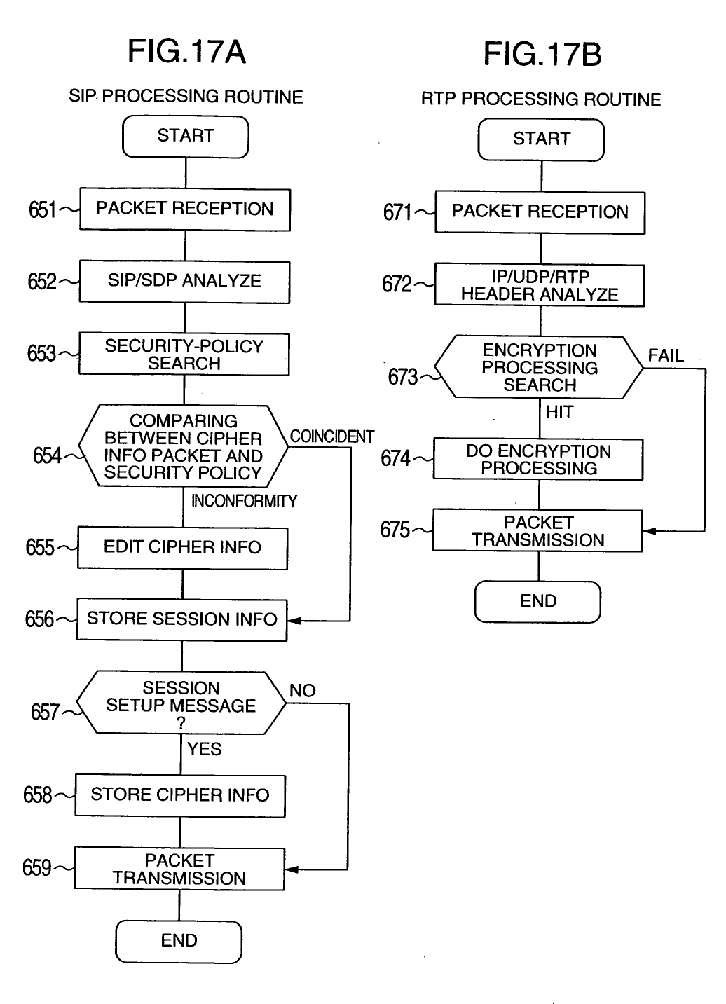

The SIP session information extract/edit program 107 executes an SIP processing routine shown in FIG. 17A when receiving an IP packet that contains an SIP message. First, analyze an SIP/SDP header (at step 651 of FIG. 17A). Based on analysis results, provide access to the security policy management table 105 to thereby search for the security policy of an RTP session to be established (at step 653). In case the cipher information in the SIP message and the security policy thus searched are different from each other, perform a cipher information add/editing operation with respect to the SIP message (at steps 654 and 655). The cipher information prior to editing and the cipher information after editing are stored in the session information management table 104 in a way corresponding to the SIP header's Call-ID or else (656). Alternatively, in case the SIP message being presently processed is the one that causes the session to transit into an established state (such as 200 OK, ACK or else in reply to INVITE), let the contents of the encryption processing thus determined be stored in the encryption processing search table 106 (at step 658).

Upon receipt of user data (RTP packet), the user data encryption processing program 108 causes an RTP processing routine shown in FIG. 17B to get started. Then, analyze the header information of such packet (such as an IP address, port number, RTP header's SSRC, and the like) (at step 672). Based on analysis results, search the type of encryption processing to be done for such packet from the encryption processing search table 106 (at step 673). Upon hitting of the encryption processing, perform the encryption processing based on the information thereof (674). Then, transfer the packet to a destination address (675).

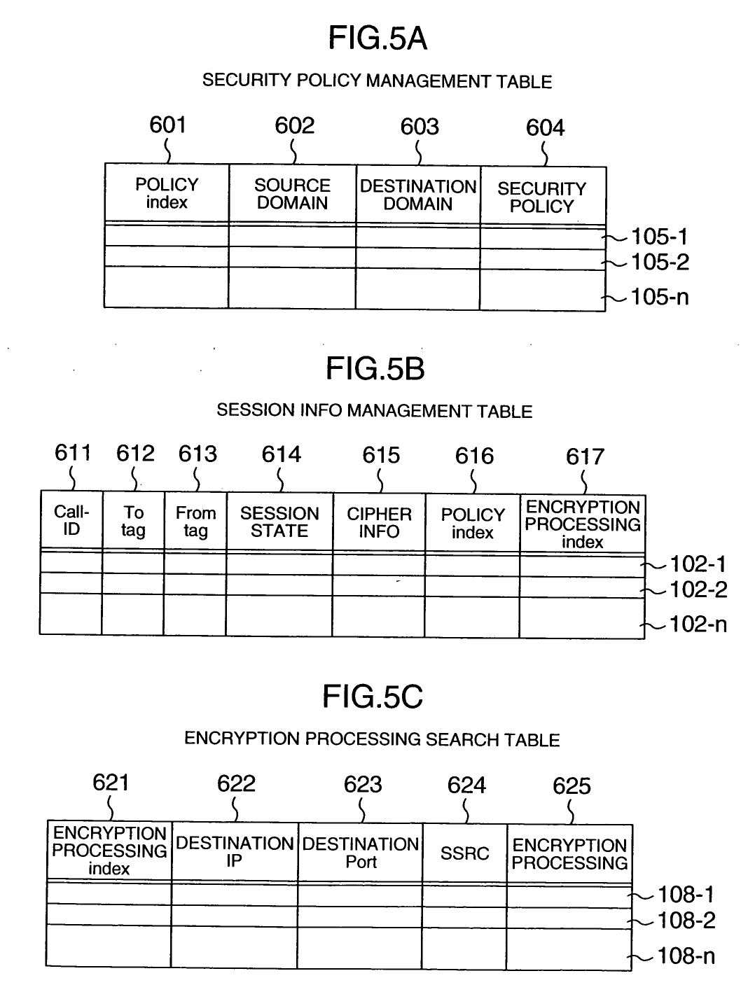

An exemplary structure of the security policy management table 105 is shown in FIG. 5A. This example is designed so that a security policy 604 indicative of the encryption processing to be done is searchable from a source domain 602 and a destination domain 603. Assigned to each entry is a policy index 601 for use as an identifier. As an example, the following information is designated to the item of security policy 604.
(1) Encryption algorithm
(2) Message authentication algorithm
(3) Key information used for encryption
(4) Key information used for message authentication
(5) Information for authenticating a party at the other end of a line

It is noted that for use as the keys for searching the type of encryption processing, information items other than those indicated in this example are usable, which are to be contained in the SIP message as indicated below.
(1) Information that identifies the source domain
(2) Information that identifies the destination domain
(3) Information identifying a source user or “sender”
(4) Information identifying a destination user
(5) Information identifying a source IP address
(6) Information identifying a destination IP address
(7) Information identifying a source port number
(8) Information identifying a destination port number
(9) Information identifying the transfer route of a signaling message
(10) Information identifying the data type or kind of a session to be established

By letting the information items (1) and (2) be search keys, it becomes possible to perform encryption in over-the-external-line phone call events only, while eliminating encryption in a company's internal extension-line links with physical security provided thereto, by way of example. It is also possible to perform encrypted communications only with specific important business partners or clients. In addition, it becomes possible to transmission or “repeat” encrypted communications between those providers who employ different encrypted communication schemes.

Using the information items (3) and (4) as search keys makes it possible to selectively encrypt only concealment-required or “secret” telephone calls, such as for example phone calls between executives in a company.

By using the information (5) to (8) as search keys, it becomes possible to determine whether encryption is necessary or not in compliance with the IP network to which users belong. For example, even where the SIP domain of interest is within a company, encryption is enabled for a phone call when a remote access is being done from a network external to the company.

By using the information (9) as a search key, it becomes possible to construct a system with enhanced flexibility while well balancing the security and maintenance costs. An example is as follows. In case an SIP message passes along a “safe” route with increased security, authentication of an associative party is eliminated with encryption keys being sent forth in the form of plaintexts. On the contrary, when the message passes along a “dangerous” route with less security, the associative-party authentication and the protection of an encryption key(s) are performed strictly.

By using the information (10) as a search key, it becomes possible to perform precise encryption control with fine adjustability pursuant to communication contents. For instance, voice data is simply transferred with no changes applied to plaintexts while applying encryption to image or video data.

FIG. 5C shows an exemplary structure of the encryption processing search table 106. In the case of using SRTP for encryption processing, the encryption processing search table 106 is arranged to register the encryption processing contents 626 with respect to a destination IP 622, a destination port 623, and an SSRC 624 for identification of a packet sender at the RTP level. Assigned to each entry is an encryption process index 621 as a unique identifier.

FIG. 5B shows an exemplary structure of the session information management table 104. In this embodiment this table is arranged to store a session state 614, cipher information 615 contained in SDP, a security policy index 616 to be applied, and an encryption processing index 617 for an “SIP Call-ID” 611 that identifies a session, “To tag” 612 and “From tag” 613. As for the security policy index 616 and encryption index 617, certain values which correspond to the policy index 601 of FIG. 5A and the encryption index 621 of FIG. 5C are stored therein respectively.

An explanation will next be given of a sequence example and a device arrangement as for the communications system of FIG. 1B.

The communications system shown in FIG. 1B is built on a data communication network 11 and another data communication network 12. At the boundary between these networks 11-12, an SIP transmission device 13 embodying the invention is installed along with a data transmission device 16. These devices are operatively cooperated together to transmit a session between terminals. In addition, an SIP server 14 is provided in the data communication network 12, for accommodation of a terminal 15 of the data communication network 11 and a terminal 17 of data communication network 12. Note here that this embodiment assumes that the terminal 15 of network 11 has no encrypting abilities, while the terminal 17 of network 12 has an encrypting ability.

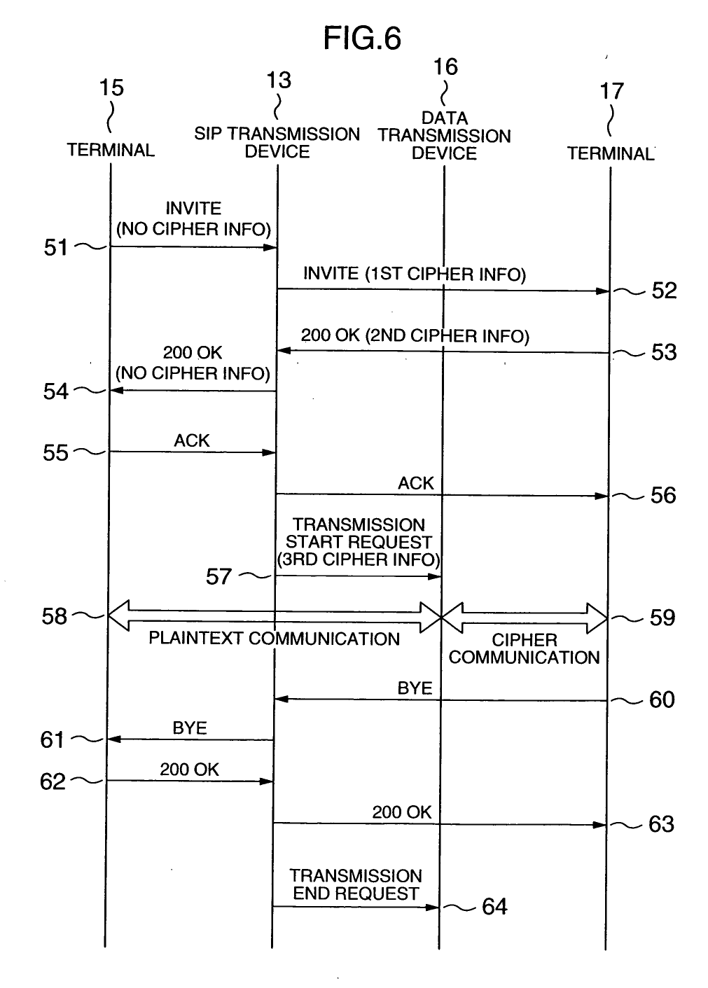

Operations of the SIP transmission device 13 and the data transmission device 16 will be explained with reference to a sequence example of FIG. 6. First, the terminal 15 sends a phone call start request (INVITE) (as indicated by reference numeral 51). This call start request does not contain any cipher information, because the terminal 15 has no encrypting abilities. When receiving the call start request from terminal 15, the session transmission device 13 adds thereto first cipher information and then transfers it to the terminal 17 (as indicated by numeral 52). Upon completion of preparation for a phone call, the terminal 17 returns a success response (200 OK) that involves second cipher information and then starts data transmission/receipt (indicated by 53). The session transmission device 13 receives the success response from terminal 17 and then deletes the second cipher information from this success response, followed by transmission to the terminal 15 (54). Upon receipt of the success response in reply to INVITE, the terminal 15 returns ACK and then starts data transmission/reception (55).

Upon completion of the transmission of ACK to the terminal 17, the session transmission device 13 transfers an transmission start request toward the data transmission device 16. This request involves the first cipher information and third cipher information as derived from the second cipher information. Based on the third cipher information thus notified, the data transmission device 16 performs encryption of data being transmitted (58, 59). In communication cut-off events, the terminal 17 sends a communication end request (BYE) via the session transmission device 13, followed by termination of data communication (60, 61). The terminal 15 returns a success response thereto and thereafter terminates the data communication (62, 63). After completion of the cutoff processing of 60-63, the session transmission device 13 sends forth an transmission end request toward the data transmission device 16 (64), followed by termination of the data transmission.

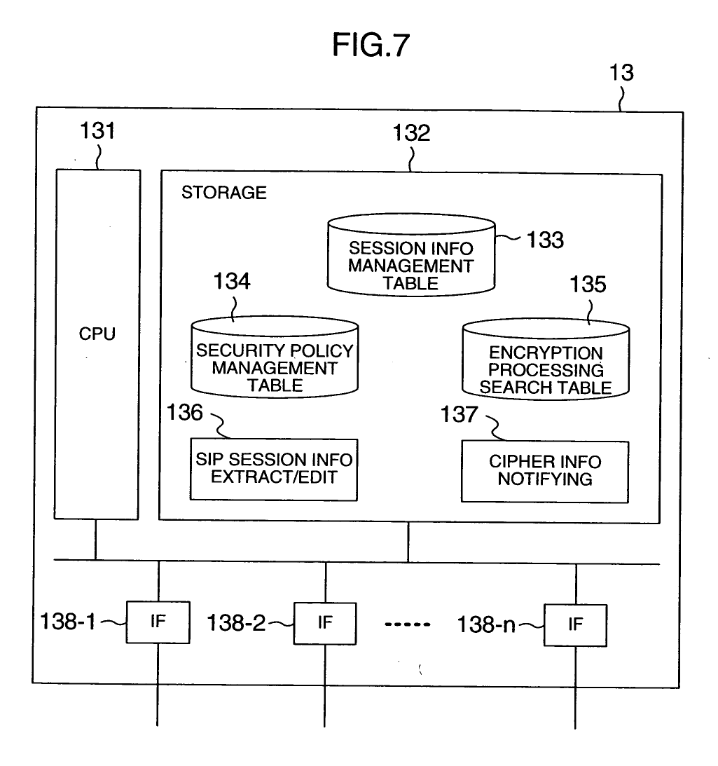

FIG. 7 shows an exemplary configuration of the SIP transmission device 13. This device includes interface units 138-1, 138-2, . . . , 138-n for accommodation of network lines, a storage device 132, and a CPU 131, which are linked together via data buses. The storage device 132 stores an SIP session information extract/edit program 136, a cipher information notify program 137, a security policy management table 134, an encryption processing search table 135, and a session information management table 133.

When receiving an IP packet that contains an SIP message, the SIP session information extract/edit program 136 searches, based on the analyzed information of an SIP/SDP header, the security policy of an RTP session to be established, from the security policy management table 134. In case the cipher information in the SIP message is different from the security policy thus searched, perform addition/edit of cipher information with respect to the SIP message. The cipher information prior to editing and the cipher information after editing are stored in the session information management table 134 in a way corresponding to the SIP header's Call-ID or the like. In case the SIP message under processing is the one that causes the session to transit into an established state (such as 200 OK, ACK or else in reply to INVITE), let the cipher information notify program 137 get started for notifying the data transmission device 16 of the contents of the encryption processing thus determined.

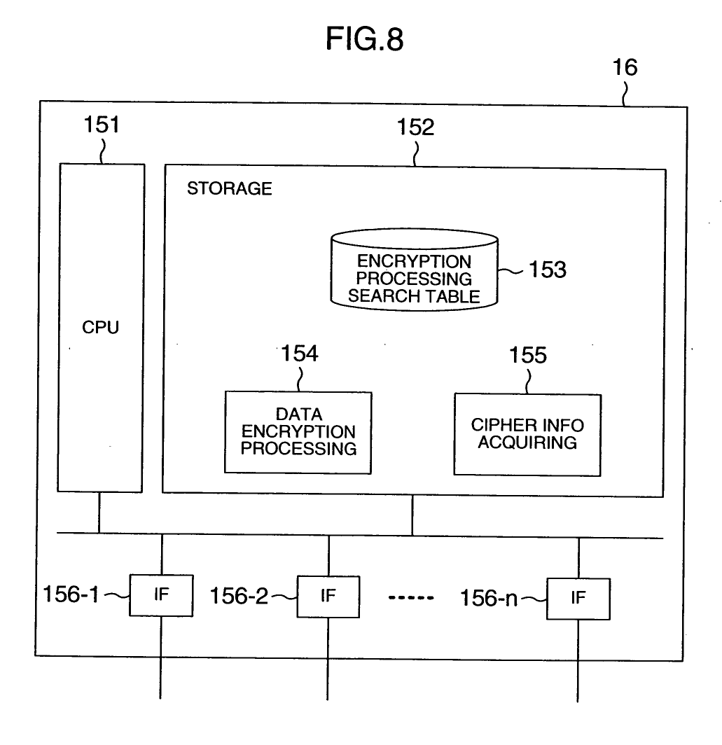

FIG. 8 shows an exemplary configuration of the data transmission device 16. This device includes interface units 156-1, 156-2, . . . , 156-n for accommodation of network lines, a storage device 152 and a CPU 151, which are linked together via buses. The storage device 152 stores a data encryption processing program 154, a cipher information acquiring program 155, and an encryption processing search table 153.

The cipher information acquiring program 155 adds to the encryption search table 153 the cipher information that was notified from the SIP transmission device 13.

Upon receiving of user data (RTP packet), the data encryption processing program 154 searches, based on the packet's header information (such as an IP address, port number, SSRC of RTP header or else), the type of encryption processing to be applied to such packet, from the encryption search table 153. If the encryption processing is found, then perform the encryption processing based on the information, followed by transmission of the packet toward a destination address.

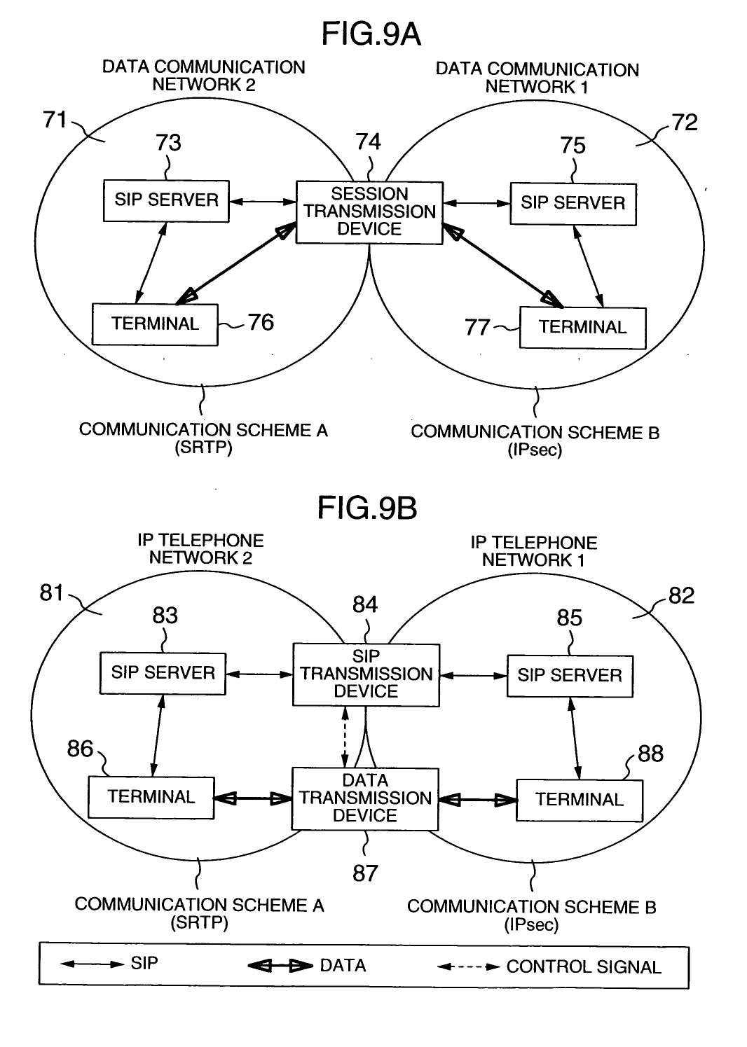

FIG. 9A, 9B shows a second exemplary configuration of the communications system in the first embodiment. This system is different from that shown in FIG. 1A, 1B in that an SIP server is provided for each of the both communication networks. This configuration is utilizable in the form of interconnection between IP telephone service companies employing different encrypted communication schemes, by way of example.

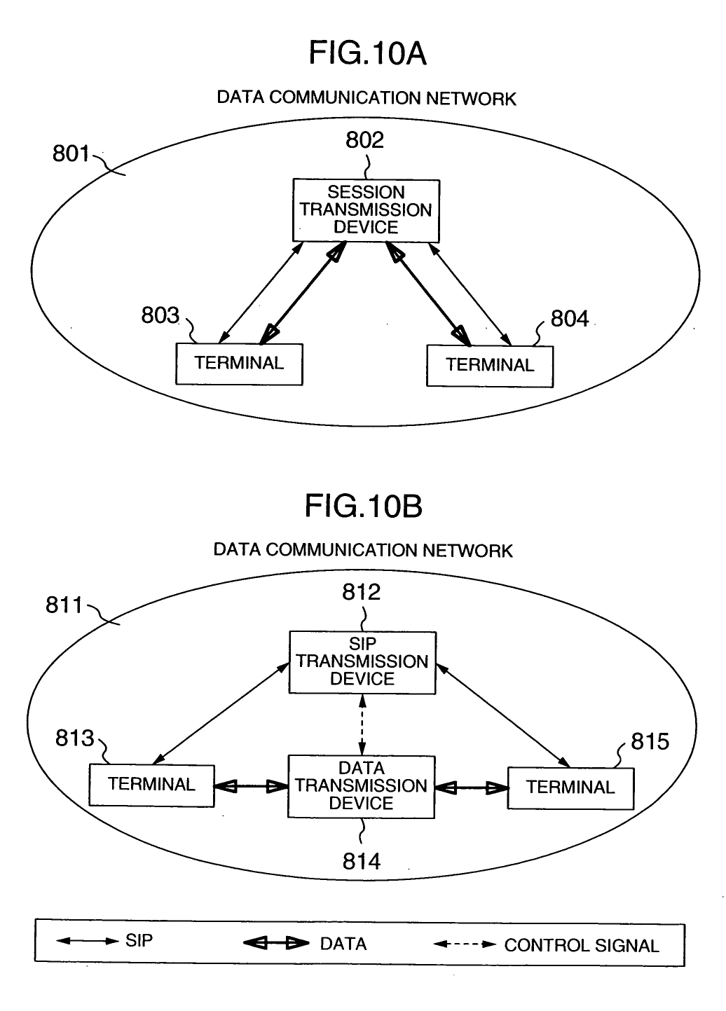

FIG. 10A, 10B shows a third exemplary configuration of the communications system in the first embodiment. This system is different from those shown in FIGS. 1A-1B and 9A-9B in that the former assumes that terminals having various kinds of encrypted communication schemes are present in a mixed manner within one or a plurality of data communication networks.

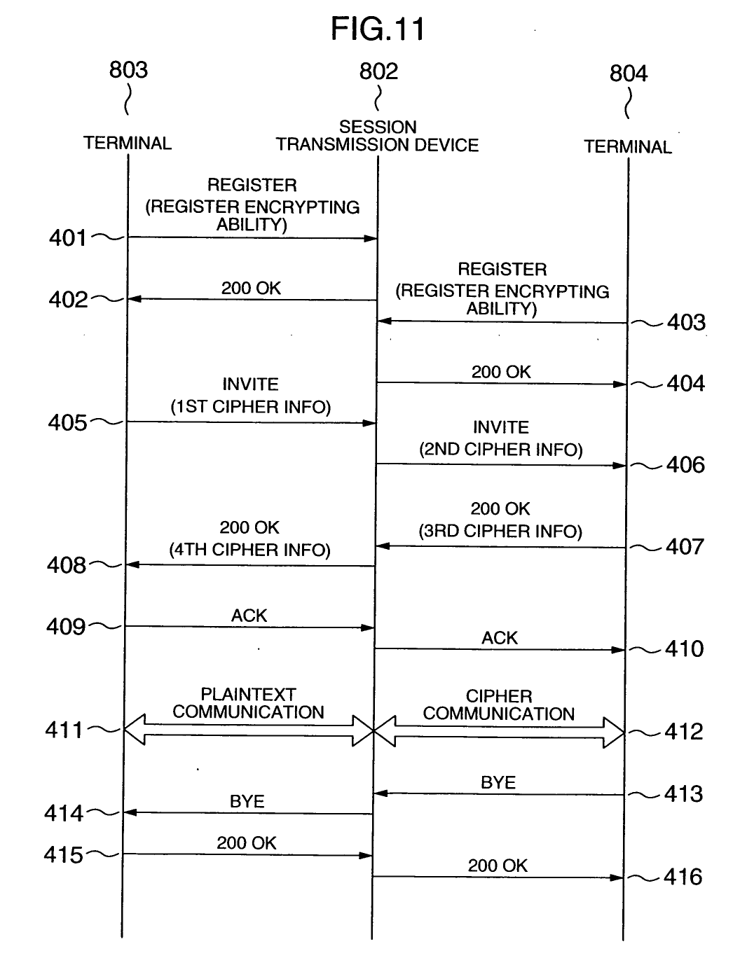

A terminal in the example of FIG. 10A employs REGISTER that is used for position registration to thereby register the terminal's encrypting ability in the session transmission device in a way as shown in FIG. 11. The session transmission device uses this information to perform conversion of encryption parameters as contained in SIP messages.

Although the scheme stated above is indicated as an example which uses SIP for session control, RTP for data transfer, and SRTP for data encryption, it is apparent that the invention is still applicable even when using other session control schemes and transport protocols.

With the use of the system and devices of the embodiment 1 stated previously, it is possible to perform encrypted communications between terminals even in cases where these terminals fail to be identical in encrypting ability to each other. Furthermore, it is also possible to prevent any communication contents from being sent forth to external networks without encryption applied thereto.

### Embodiment 2

In prior art systems, there is a problem as to the lack of an ability to perform, on the network side, monitoring and recording of communication contents when performing exchange of cipher information during signaling and encryption of data between terminals.

Consequently in a second embodiment, there will be shown an example of the invention which solves the above-noted problem.

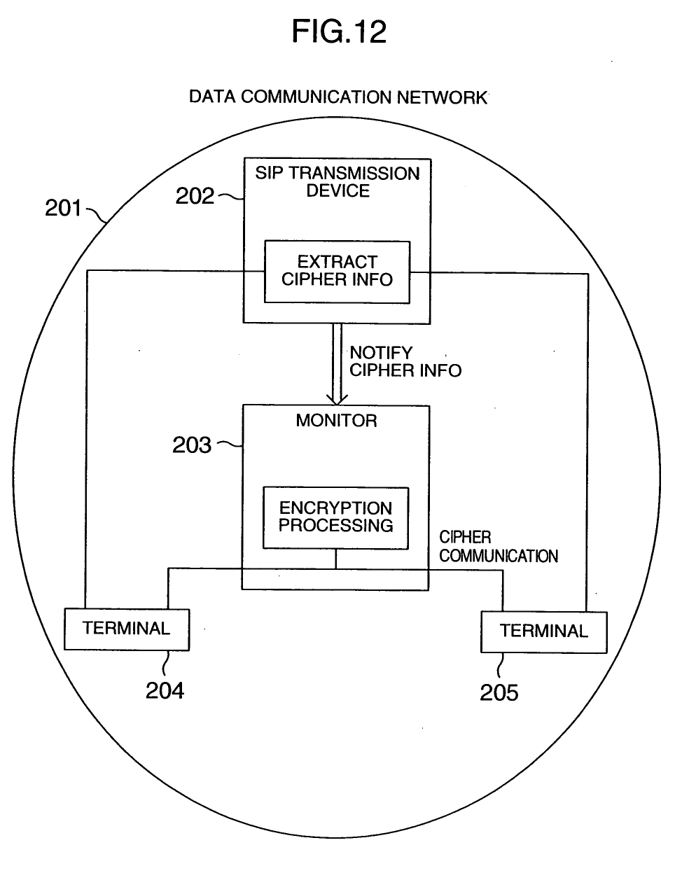

FIG. 12 shows an exemplary configuration of a communications system that solves the second problem stated supra. This system is made up of a data communication network 201 and several devices connected thereto, including an SIP transmission device 202, a monitor device 203 and terminals 204-205. The SIP transmission device 202 is operable to intermediately deliver signaling between the terminals. The monitor device 203 stores or displays the communication contents between the terminals in a way corresponding to the session information notified from the SIP transmission device. The terminals 204 and 205 have data encrypting functions so that encrypted communication is enabled between the terminals.

In prior art systems, it has been impossible to allow the monitor device 203 to monitor any communication contents in cases where encryption is done between terminals. However, according to the system embodying this invention sought to be patented, the SIP transmission device 202 is designed to notify the monitor device 203 of the cipher information that was extracted from the SIP signaling, thereby making it possible for monitor device 203 to decrypt the encrypted communication between the terminals.

Note here that the cipher information to be notified by the SIP transmission device 202 to the monitor device 203 contains the following contents, for example.
(1) Encryption algorithm
(2) Message authentication algorithm
(3) Key information used for encryption
(4) Key information used for message authentication
(5) Information for performing the authentication of an associative party at the other end of a line

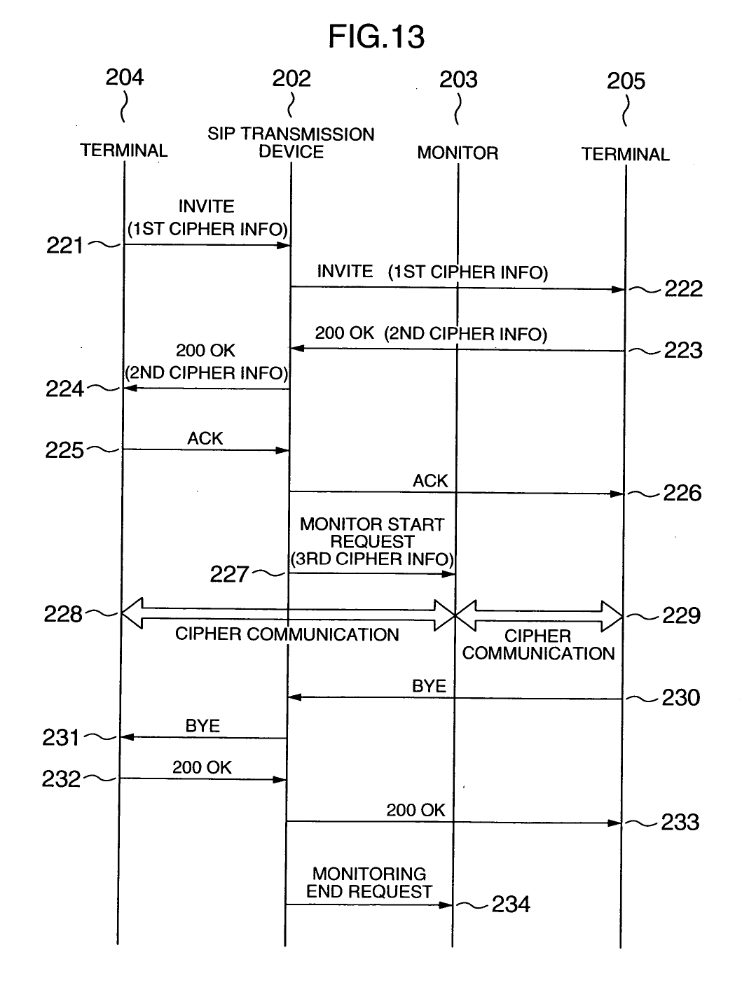

FIG. 13 shows one exemplary communication sequence in this embodiment. This shows an example that the monitor device 203 decrypts encrypted data to be communicated between the terminals 204 and 205 in accordance with the information as notified by the SIP transmission device 202.

First, the terminal 204 transmits a phone call start request (INVITE) (as indicated by numeral 221 in FIG. 13). The SIP transmission device 202 stores therein first cipher information being contained in this request in a way corresponding to session information, and then sends it to the terminal 205 (indicated by 222). After completion of the preparation for a call, the terminal 205 sends back a success response (200 OK) in which second cipher information is contained, and then begins to perform a data send/receive operation (223). The SIP transmission device 202 stores therein the second cipher information and then sends it to the terminal 204 (224). The terminal 204 returns ACK and then starts transmission/reception of data (225).

Upon completion of intermediary delivery of ACK, the SIP transmission device 202 notifies the monitor device 203 of a monitor start request (227). This monitor start request involves the first cipher information and third cipher information that was created from the second cipher information. Owing to the above-noted procedure, encrypted communication gets started between the terminals (228, 229). In this respect, the monitor device 203 is capable of decrypting the encrypted data that was captured on the network in accordance with the information notified from the SIP transmission device 202. When the communication is disconnected, the terminal 205 sends a call end request (BYE) by way of the SIP transmission device 202 (230, 231). In responding thereto, the terminal 204 returns a success response (232, 233). When sending the success response in reply to BYE, the SIP transmission device 202 notifies the monitor device 203 of an transmission end request (234).

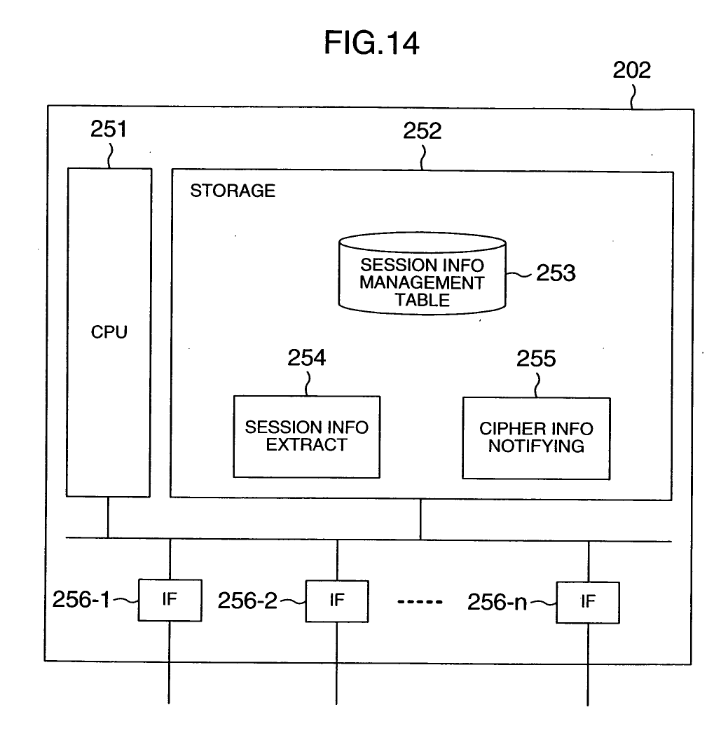

FIG. 14 shows an exemplary configuration of the SIP transmission device 202. This device includes interface units 256-1, 256-2, . . . , 256-n for accommodation of network lines, a storage device 252 and a CPU 251, which are linked together via buses. The storage device 252 stores an SIP session information extracting program 254, a cipher information notifying program 255, and a session information management table 253.

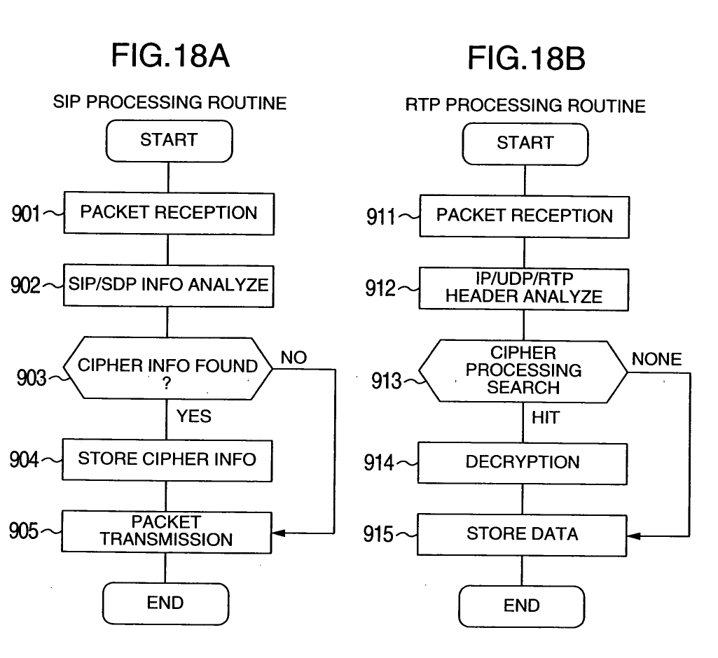

When receiving an IP packet which contains an SIP message, the SIP session information extracting program 254 executes an SIP processing routine shown in FIG. 18A. Analyze an SIP/SDP header (902). If cipher information is contained therein, then store its contents in the session information management table 253 in a way corresponding to the SIP header's Call-ID or the like (903, 904). In case the SIP message being presently processed is the one that causes the session to transit into an established state (such as 200 OK, ACK or else in reply to INVITE), let the cipher information notify program 255 get started for notifying the monitor device 203 of the contents of encryption processing thus determined.

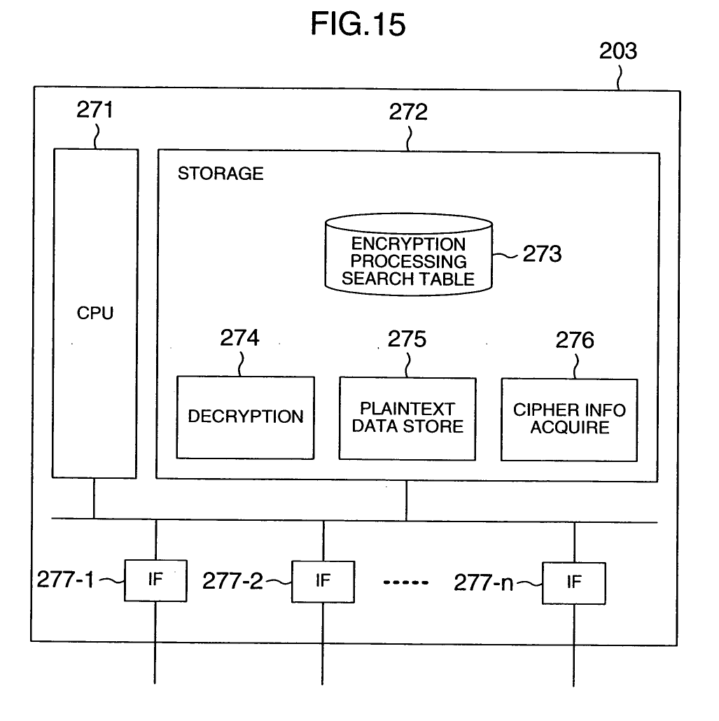

FIG. 15 shows an exemplary configuration of the monitor device 203. This device includes interface units 277-1, 277-2, . . . , 277-n for accommodation of network lines, a storage device 272 and a CPU 271, which are linked together via buses. The storage device 272 stores a decryption processing program 274, a cipher information acquiring program 276, an encryption processing search table 273, and a plaintext data storage program 275.

The cipher information acquiring program 276 adds to the encryption processing search table 273 the cipher information that is notified from the SIP transmission device 202.

Upon receipt of user data (RTP packet), the decryption program 274 allows startup of an RTP processing routine shown in FIG. 18B. Analyze the packet's header information such as an IP address, port number, RTP header's SSRC, etc. (at step 912). Then, provide access to the encryption search table 273 for searching and finding therefrom the encryption processing to be performed for the packet of interest (at step 913). If appropriate encryption processing is found, then perform decryption processing of the packet based on such information (914). Let the plaintext data storage program 275 get started, for storing decrypted data (915).

With the use of the system and devices of the embodiment 2 stated above, it is possible to monitor and record the communication contents on the network even when data encryption is done between terminals.

### Embodiment 3

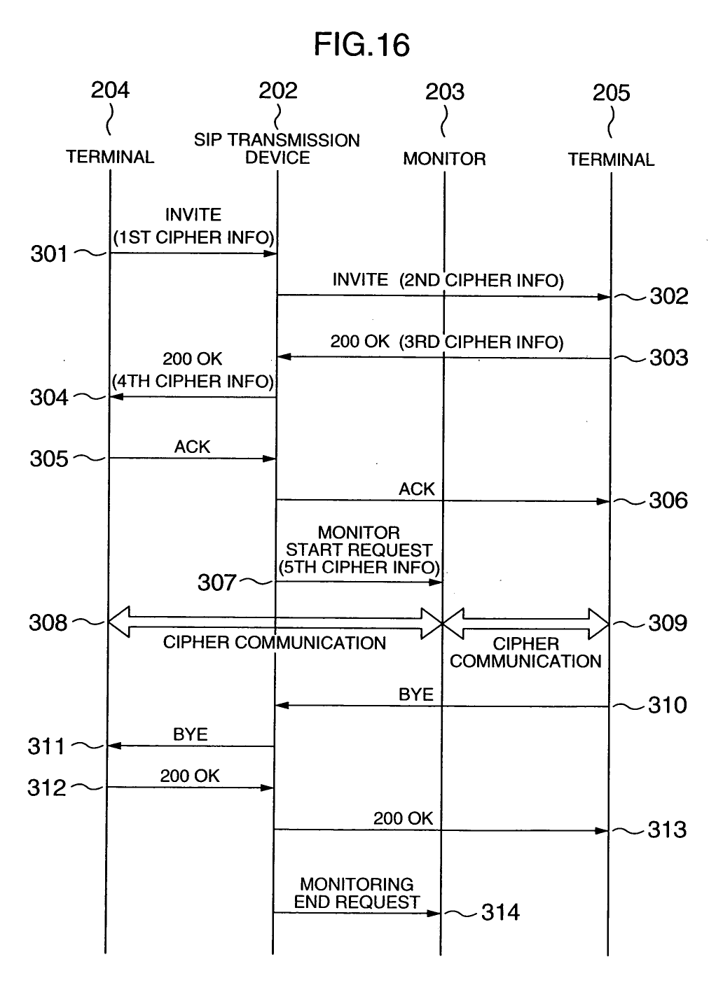

Although in the embodiment 2 one specific scheme was employed for causing the SIP transmission device 202 to extract the cipher information as contained in the signaling, the SIP transmission device 202 may be arranged to perform conversion of cipher information in the signaling delivery event in cases where the monitor device 203 is designed to perform intermediary delivery of data. An example of such communication sequence using this scheme is shown in FIG. 16. In this example, what is done first is that the terminal 204 sends a call start request (INVITE) (indicated by numeral 301). The SIP transmission device 202 stores first cipher information as contained therein in a way corresponding to session information and, at the same time, converts it into second cipher information for transfer to the terminal 205 (302). Upon completion of the preparation for a call, the terminal 205 returns a success response (200 OK) in which third cipher information is involved, followed by startup of a data send/receive operation (303).

The SIP transmission device 202 stores therein the third cipher information and then converts it to fourth cipher information, which will be sent to the terminal 204 (at step 304). The terminal 204 returns ACK and then begins to perform a data send/receive operation (305). In response to delivery of ACK (306), the SIP transmission device 202 notifies the monitor device 203 of a monitor start request (307). This monitor start request contains fifth cipher information as created from the first, second, third and fourth cipher information. Owing to the above-noted procedure, encrypted communication gets started between the terminals (308, 309). The monitor device 203 intermediately delivers the terminal-to-terminal encrypted communication based on the fifth cipher information that was notified from the SIP transmission device. Additionally it stores or displays the communication contents thus decrypted.

In a communication cutoff event, the terminal 205 sends a call end request (BYE) via the SIP transmission device 202 (as indicated by numerals 310 and 311 in FIG. 16). In responding thereto, the terminal 204 returns a success response (312, 313). When the success response is sent in reply to BYE, the SIP transmission device 202 notifies the monitor device 203 of an transmission end request (314).

Using the system and devices of the embodiment 3 stated above makes it possible to achieve encrypted communications even in cases where communication is done between terminals which belong to networks capable of encrypting data by mutually different schemes. It is also possible to monitor and record any communication contents on the networks.

It should be further understood by those skilled in the art that although the foregoing description has been made on embodiments of the invention, the invention is not limited thereto and various changes and modifications may be made without departing from the spirit of the invention and the scope of the appended claims.

1. A network system having a control data transmission device and a user data transmission device as connected via a network to a first terminal with an encrypting function and a second terminal without the encrypting function, wherein
said control data transmission device comprises:
a receiving unit for receiving control data as sent from the first terminal to the second terminal;
a data processing unit for extracting cipher information of the first terminal from said control data;
a memory retaining the cipher information of said first terminal; and
a sending unit for sending the control data from which the cipher information has been deleted toward the second terminal, or sending to the first terminal the control data with the cipher information added thereto, and further sending the cipher information to said user data transmission device, and wherein
said user data transmission device includes an encryption processing unit for decrypting, based on said cipher information, the data as sent from said first terminal to said second terminal while encrypting the data as sent from said second terminal to said first terminal.

2. The network system according to claim 1, wherein upon receipt of a request for non-encryptable communication as sent from said second terminal to said first terminal, said control data transmission device sends to said second terminal a notice as to refusal of data transmission.

3. The network system according to claim 1, wherein said control data transmission device determines addition or deletion of the cipher information based on at least one as selected from the group consisting of information identifying a sending source drain, information identifying a destination domain, information identifying a user who is a sender, information identifying a destination user, information identifying a source IP address, information identifying a destination IP address, information identifying a source port number, information identifying a destination port number, information identifying a transfer route of the control data, and information identifying a data type of a session to be established between the first and second terminals.

4. A network system having a control data transmission device and a user data transmission device as connected via a network to a first terminal with an encrypting function and a second terminal without the encrypting function, wherein
said control data transmission device comprises:
a receiving unit for receiving control data as sent from the first terminal to the second terminal;
a data processing unit for adding cipher information to the control data; and
a sending unit for sending to said first terminal the control data with the cipher information added thereto and for sending the cipher information to the user data transmission device, and wherein
said user data transmission device includes an encryption processing unit for decrypting, based on said cipher information, the data as sent from said first terminal to said second terminal while encrypting the data as sent from said second terminal to said first terminal.

5. A control data transmission device connected via a network to a plurality of terminals and to a user data transmission device, comprising:
a send/receive unit for receiving a packet as sent from one of the plurality of terminals and for sending it to another terminal included in said plurality of terminals;
an edit method decision processing unit for determining, based on contents of the packet thus received, necessity of cipher information editing and an editing method; and
a cipher information processing unit for notifying said user data transmission device of the necessity of cipher information editing and the editing method.

6. The control data transmission device according to claim 5, wherein said edit method decision processing unit determines a cipher information editing method based on at least one of information items in the packet thus received, which include information that identifies a sending source drain, information identifying a destination domain, information identifying a sending source user, information identifying a destination user, information identifying a source IP address, information identifying a destination IP address, information identifying a source port number, information identifying a destination port number, information identifying a transfer route of the control data, and information identifying a data type of a session to be established.

7. A user data transmission device connected via a network to a plurality of terminals and a control data transmission device, comprising:
a send/receive unit for receiving a packet as sent from one of the plurality of terminals and for sending it to another terminal included in said plurality of terminals; and
an encryption processing unit for applying any one of encryption and decryption to the received packet in accordance with the cipher information received from said control data transmission device.

8. A session monitor system connected via a network with a control data transmission device and a session monitor device connected to a plurality of terminals, wherein said control data transmission device comprises:
means for receiving a packet as sent from one terminal to another terminal in said plurality of terminals;
means for extracting cipher information from the packet; and
means for notifying the cipher information to the session monitor device, and wherein
said session monitor device includes means for decrypting, based on the cipher information, communication contents between said one terminal and said another terminal.

9. A packet monitor device connected via a network to a plurality of terminals and a control data transmission device, comprising:
a send/receive unit for receiving a packet as sent from one of the plurality of terminals and for sending it to another terminal included in said plurality of terminals; and
a decryption processing unit for applying any one of encryption and decryption to the packet in accordance with the cipher information as received from said control data transmission device.
